(19) United States
(12) Patent Application Publication
(10) Pub. No.: US 2024/0127107 A1
(43) Pub. Date: Apr. 18, 2024

(54) PROGRAM ACCELERATORS WITH MULTIDIMENSIONAL NESTED COMMAND STRUCTURES

(71) Applicant: Microsoft Technology Licensing, LLC, Redmond, WA (US)

(72) Inventors: Haishan ZHU, Bellevue, WA (US); Eric S. CHUNG, Woodinville, WA (US)

(21) Appl. No.: 17/966,637

(22) Filed: Oct. 14, 2022

(51) Int. Cl. G06N 20/00

(52) U.S. Cl. CPC G06N 20/00

(57) ABSTRACT

Embodiments of the present disclosure include techniques for machine language processing. In one embodiment, the present disclosure include commands with data structures comprising fields describing multi-dimensional data and fields describing synchronization. Large volumes of data may be processed and automatically synchronized by execution of a single command.

### BACKGROUND

The present disclosure relates generally to machine language processing, and in particular, to program accelerators with multidimensional nested command structures.

Contemporary machine learning uses special purpose processors optimized to perform machine learning computations. Such processors are commonly referred to as machine learning accelerators. These devices typically receive control information and data. The control information configures the processor to process the data and generate results. One of the most common machine learning systems are systems optimized to process neural networks.

The throughput of machine learning accelerators has been increasing at a staggering pace. Modern accelerators, such as the H100 GPU from Nvidia®, offers up to 4000 tera FLOPS of tensor core throughput, and 3 TB/s of main memory bandwidth. With these drastic increases in data path throughput, it also becomes increasingly expensive to supply commands to the processors to avoid control bottlenecks.

Notably, much of the increase originates from factors such as shrinking the transistor size and data type innovations, while less may come from higher frequencies. For example, over the last three generations of GPUs, transistor counts have increased by about 4×, dense throughput has increased by about 8×, and memory bandwidth has increased by about 3×, with far less frequency improvements. Also, the introduction of sparse data types provides approximately another 2× improvement to effective peak computation throughput.

As a result of this trend, it becomes increasingly expensive to satisfy command bandwidth requirements to avoid control throughput bottlenecks. Specifically, instruction bandwidths typically have to increase with computation throughput, consuming very limited memory bandwidth which increases much slowly in comparison. Also, production model size does not always increase as quickly as computation peak throughput. To fully leverage the throughput, high instruction bandwidths and low control latency can be beneficial.

### BRIEF DESCRIPTION OF THE DRAWINGS

FIG. 1 illustrates a system for processing multi-dimensional data according to an embodiment.

FIG. 2 illustrates a method of processing multi-dimensional data according to an embodiment.

FIG. 3A illustrates an example data movement command according to an embodiment.

FIG. 3B illustrates example hardware resources used in a data movement command according to an embodiment.

FIG. 4 illustrates an example matrix multiplication command according to an embodiment.

FIG. 5 depicts a simplified block diagram of an example system according to some embodiments.

### DETAILED DESCRIPTION

Described herein are techniques for multidimensional nested command structures. In the following description, for purposes of explanation, numerous examples and specific details are set forth in order to provide a thorough understanding of some embodiments. Various embodiments as defined by the claims may include some or all of the features in these examples alone or in combination with other features described below and may further include modifications and equivalents of the features and concepts described herein.

Features and advantages of the present disclosure include programming machine learning processors (aka, accelerators) with a new type of command structure that describes operations on multi-dimensional data. In various embodiments, the new structure may support higher instruction encoding density and help avoid control bottlenecks on modern machine learning accelerators. Certain embodiments may also enable data and control synchronization at fine granularity, which may create opportunities for fusion of kernel processes, for example.

In some example embodiments described herein, commands encode layout information of high dimensional data (e.g., high-dimensional matrices) using information like base address, size of each dimension, stride size for each dimension, data type, etc. Accordingly, each command may address significantly more data than traditional encoding mechanisms, thus significantly increasing instruction encoding density, especially when repeating the same operation for a large amount of data.

In certain example embodiments, the granularity at which synchronization is performed can be encoded in the commands. Since each command may address a large amount of data and take considerable amount of time to complete, waiting for a command to finish before any dependent command can start may lead to low utilization of on-chip resources and high buffering capacity requirements. Techniques described herein may allow multiple hardware commands to synchronize on a large chunk of data (e.g., in main memory) without having to implement expensive dependency tracking for a large number of addresses, for example.

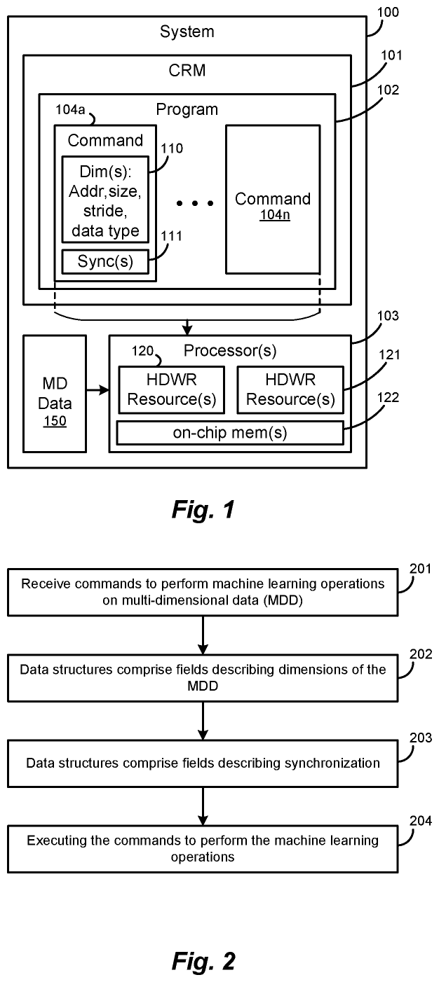

FIG. 1 illustrates a system for processing multi-dimensional data according to an embodiment. System 100 may comprise a non-transitory computer-readable medium (CRM) 101 and one or more processors 103. CRM 101 may be one or more of a wide range of memories (e.g., DRAM, solid state drives, etc. . . . ). CRM 101 stores a program 102 executable by processor(s) 103, the program 102 comprising sets of instructions for performing the techniques described herein. For instance, program 103 may comprise commands 104a-n (or “tasks” or “task descriptors”), which advantageously describes operations on multi-dimensional data. For example, commands 104a-n may comprise data structures having a plurality of fields 110 describing a plurality of dimensions of the multi-dimensional data and a plurality of fields 111 describing synchronization of a particular command process with one or more other processes at a plurality of occurrences of partial completion of the particular command process, for example. Processor(s) 103 may receive a plurality of such commands to perform machine learning operations (e.g., neural network operations) on multi-dimensional data 150 stored in whole or in part in off-processor memory or on-processor memory, for example. Processor(s) 103 may execute the commands to perform the machine learning operations on the multi-dimensional data. Processor(s) 103 may comprise various hardware resources 120a-n for performing the operations. Hardware resources may include multiplication units, vector processors, tensor processors, transformers, quantizers, or arithmetic (e.g., softmax) hardware units or the like, for example, in addition to one or more on-chip memory units 122.

Features and advantages of the present disclosure include efficient processing of multi-dimensional data (sometimes referred to herein as “MDD”). MDD may comprise tensors, for example, which are multi-dimensional arrays of data typically comprising a plurality of elements along a plurality of axes (e.g., along 1, 2, 3, or more dimensions). Commands 104a-n may perform a function on one or more complete tensors without the execution of other commands, for example. Example commands may include various forms of data movement operations, matrix multiplication operations, and others, examples of which are provided below.

As mentioned above, commands advantageously describe operations on the multi-dimensional data, which may be multi-dimensional matrices of data, where the commands encode the dimensions of the multi-dimensional matrices of data. For example, in various embodiments, commands may specify a plurality of dimension sizes for a plurality of dimensions of one or more matrices. In some embodiments, the commands comprise a base address for at least one multi-dimensional matrix of data. In some embodiments, the commands comprise a size of each dimension for at least one multi-dimensional matrix of data. In some embodiments, the commands comprise a stride size for at least one multi-dimensional matrix of data. In some embodiments, the commands comprise a data type for at least one multi-dimensional matrix of data. In certain examples shown below, the commands comprise a base address, a size of each dimension, a stride size, and a data type for at least one multi-dimensional matrix of data.

Features and advantages of the present disclosure include commands that efficiently process large volumes of machine learning data. For example, some commands may repeat a plurality of same operations on the multi-dimensional data (e.g., by only executing the command once, rather than multiple times). In some embodiments, data addressed by the command may be of arbitrary size, may not fit in on-chip memory, and may be located in main memory, for example. Accordingly, a command may address particular multi-dimensional data that does not fit within on-chip memory of a particular processor, for example. Additionally, at least a portion of the particular multi-dimensional data operated on during execution of the command may be stored in main memory (e.g., external off-chip RAM).

Features and advantages of the innovative commands may include encoding synchronization points. For example, a plurality of commands may synchronize on a partially processed multi-dimensional data set at various synchronization points defined within the commands, for example. In particular, a dependent command may synchronize with a partially processed multi-dimensional data set in main memory or on-chip memory being operated on by another command. Synchronization may be implemented in a number of ways. For example, a command may executes a wait on the occurrence of a predefined event specified in the command. In some embodiments, a command may perform a data transaction on the occurrence of a predefined event specified in the command. In some embodiments, a command may generate a signal on the occurrence of a predefined event specified in the at least one command. Examples of waits, data transactions, and signals encoded in the commands are provided in more detail below. In various embodiment, synchronization can be performed by a number of different ways, including semaphore, mutex, atomic load/stores, etc.

FIG. 2 illustrates a method of processing multi-dimensional machine learning data according to an embodiment. At 201, a processor receives a plurality of commands to perform machine learning operations on multi-dimensional data (MDD). The commands comprise data structures. At 202, the data structures comprise a plurality of fields describing a plurality of dimensions of the multi-dimensional data (MDD). At 203, the data structures comprise a plurality of fields describing synchronization of a particular command process with one or more other processes at a plurality of occurrences of partial completion of the particular command process. At 204, the processor executes the commands to perform the machine learning operations on the multi-dimensional data.

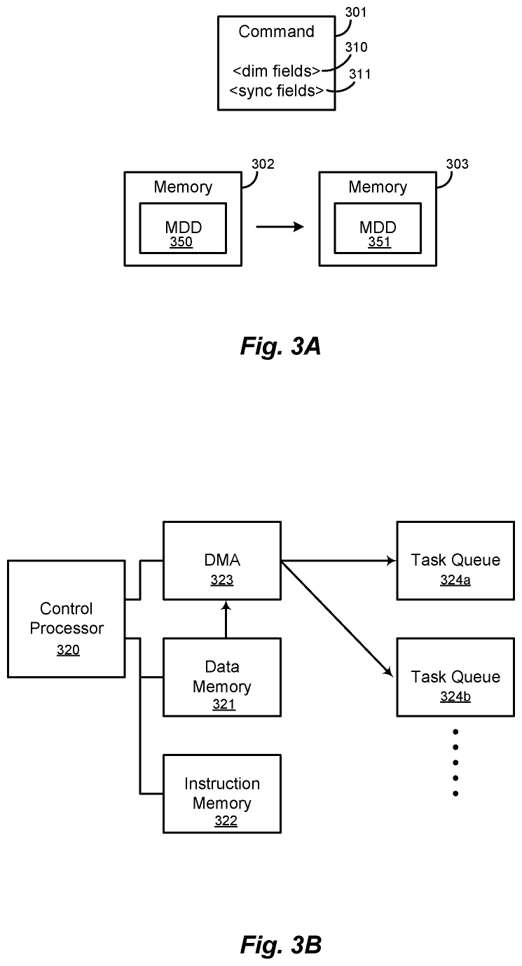

FIG. 3A illustrates an example data movement command according to an embodiment. In this example, execution of command 301 causes MDD 350 to be moved from one memory 302 to another memory 303. Memories 302 and 303 may be on-chip, off-chip, or combinations of on and off chip memories or the same memory, for example. Command 301 may include an instruction to transform MDD 350 as part of the transfer process to produce MDD 351, for example. As mentioned above, commands may be data structures with various fields, such as dimension fields 310 and synchronization fields 311.

One example command instructs a direct memory access (DMA) circuit to perform data movement and transformation. This command may have software controlled fine-grained synchronization as well as multi-dimension transfers with striding and transpose. Software controlled fine-grained synchronization is nested commands that enables software to specify synchronization granularity of a long running DMA operation. This allows multiple other processors to pipeline the computation, while avoiding the overhead of frequent control processor intervention. Multi-dimension transfers with striding and transpose operates on multi-dimension logical tensors, with address striding support at each dimension, for example. Transpose, padding, and type conversions can be layered on these multi-dimension tensor transfers, for example, giving the software the flexibility to form coarse commands and minimizes control processor overhead on loops and task dispatch bandwidth.

Data structures for commands may be defined as follows:

```
Struct <structname> {
  <predefined field1> <field_name>
  <predefined field2> <field_name>
  <predefined field3> <field_name>
Etc...
```

The following illustrates example predefined fields of one type of data movement command or task descriptor.

```
struct TdmaDescType1 {
  int transpose_mat;
  MemoryId src_mem_id;
  DataType src_data_type;
  MemoryId dst_mem_id;
  DataType dst_data_type;
  int src_base_addr;
  int src_dim0;
  int em_src_ready_valid;
  int src_dim1;
  int sem_src_ready_val;
  int src_dim2;
  int sem_src_ready_id;
  int src_dim3;
  int sem_src_valid_valid;
  int src_part_dim0;
  int sem_src_valid_val;
  int src_part_dim1;
  int sem_src_valid_id;
  int src_part_dim2;
  int src_part_dim3;
  int src_dim0_stride;
  int src_dim1_stride;
  int src_dim2_stride;
  int src_dim3_stride;
  int src_part_dim0_stride;
  int src_part_dim1_stride;
  int src_part_dim2_stride;
  int src_part_dim3_stride;
  int dst_base_addr;
  int dst_dim0;
  int sem_dst_ready_valid;
  int dst_dim1;
  int sem_dst_ready_val;
  int dst_dim2;
  int sem_dst_ready_id;
  int dst_dim3;
  int sem_dst_valid_valid;
  int dst_part_dim0;
  int sem_dst_valid_val;
  int dst_part_dim1;
  int sem_dst_valid_id;
  int dst_part_dim2;
  int dst_part_dim3;
  int dst_dim0_stride;
  int dst_dim1_stride;
  int uint32_t dst_dim2_stride;
  int dst_dim3_stride;
  int dst_part_dim0_stride;
  int dst_part_dim1_stride;
  int dst_part_dim2_stride;
  int dst_part_dim3_stride;
};
```

Example descriptions of the fields are set forth in Table 1.

TABLE 1

| Field Name | Description | | |
|---|---|---|---|
| transpose_mat | Transpose a matrix. | | |
| src_mem_id | Memory ID for source and destination. | | |
| dst_mem_id | | | |
| src_data_type | Data type at source and destination. | | |
| dst_data_type | | | |
| src_base_addr | Starting address of source and destination. | | |
| dst_base_addr | | | |
| src_dim[0, 1, 2, 3] | Dimension of the tensor at source and destination. In unit of the | | |
| dst_dim[0, 1, 2, 3] | respective data type. Dim3 refers to the innermost dimension and | | |
| | dim0 the outermost dimension. | | |
| src_part_dim[0, 1, 2, , 3] | The sub-partition dimension of the DMA transfer on which to | | |
| dst_part_dim[0, 1, 2, 3] | perform semaphore synchronizations for source and destination. | | |
| src_dim[0, 1, 2, 3]_stride | Address increment step for each dimension. The unit of stride is | | |
| dst_dim[0, 1, 2, 3]_stride | the same as that for base_address. | | |
| sem_src_ready_valid | The semaphores to wait and signal at the source and destination. | | |
| sem_src_ready_val | DMA will: | | |
| sem_src_ready_id | | • | Perform a wait on sem_src_valid |
| sem_src_valid_valid | | • | Perform a wait on sem_dst_rdy |
| sem_src_valid_val | | • | Transfer sem_tile_dim of data |
| sem_src_valid_id | | • | Perform a signal on sem_dst_valid |
| sem_dst_ready_valid | | • | Perform a signal on sem_src_rdy |

sem_dst_ready_val
sem_dst_ready_id
sem_dst_valid_valid
sem_dst_valid_val
sem_dst_valid_id

FIG. 3B illustrates example hardware resources used in a data movement command according to an embodiment. In this example, control processor 320 may execute the command stored in instruction memory 322 to cause a data transfer between data memory 321 using at least one task queues 324 (there may be multiple task queues, for example). To alleviate pressure on the control processors, task descriptors can invoke large chunks of coarse-grained tasks on a processor (e.g., thousands of cycles). These coarser-grained tasks, or nested tasks, can also instruct the target processor to synchronize with a global semaphore block upon a subset of the work being complete (e.g., a portion of matrix multiplication result is computed, or a portion of data movement is complete). This allows processors to pipeline computation at a granularity specified by the software without additional control processor intervention.

Commands are populated by the control processor in its local data memory 321 as a contiguous structure. Once formed, the entire command can be pushed into a task queue by invoking a DMA operation that copies the structure from the data memory 321 into the specified task queue. Note that the control processor may not be required to construct a new command (aka task descriptor) from scratch every time. Rather, control processor 320 may update the fields of an existing struct in memory 321 that have changed and push the updated command to the queue. In some example embodiments, control processors are implemented using an Intel Nios II/f processor, which is a fully programmable and configurable 32-bit FPGA soft processor, packaged with a C/C++ GCC toolchain, for example. In other embodiments, the control processors may be field programmable gate arrays (FPGA) or application specific integrated circuits (ASIC), for example. The system may use a global semaphore block for synchronization, for example. Multiple processors in a system may synchronize with each other using the semaphore block (e.g., using counting semaphore semantics). A semaphore system may employ a client-server architecture, where semaphore clients split commands and issue wait commands as early as possible. A semaphore block serves the requests and may be fully pipelined to handle one wait and one signal per cycle at peak throughput. The semaphore block supports the logical operations shown in Table 2.

TABLE 2

| Operation | Parameter | Semantics |
|---|---|---|
| wait | SemaphoreID | Blocks until the value of semaphore at sem_id is larger |
| | sem_id, | than or equal to sem_val, after which decrements the |
| | Int sem_val | value of semaphore sem_id by sem_val. |
| | | wait returns 0 on completion. |
| signal | SemaphoreID | Increases the value of semaphore sem_id by sem_val. |
| | sem_id, | |
| | Int sem_val | |
| set | SemaphoreID | Sets the value of semaphore sem_id to value sem_val. |
| | sem_id, | This command is used by control processor for |
| | Int sem_val | initialization. |
| try_wait | SemaphoreID | If the value of semaphore sem_id is larger than or equal |
| | sem_id, | to sem_val, decrement its value by sem_val and return 0 |
| | Int sem_val | (success). Otherwise, return 1 (failure) and do not change |
| | | the value of the semaphore. |

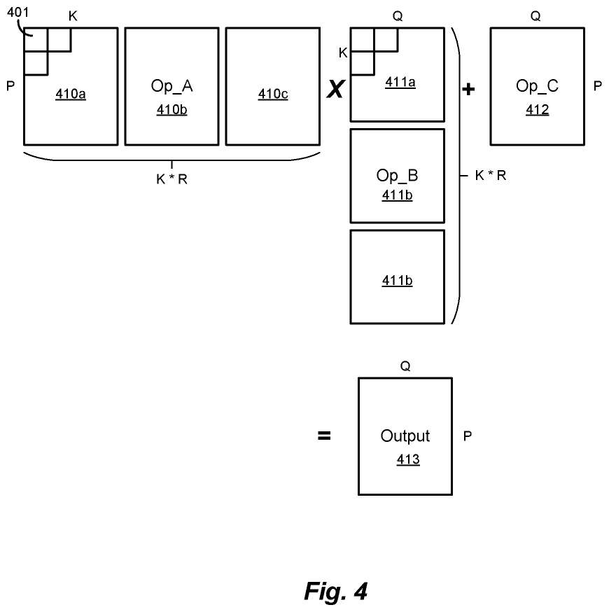

FIG. 4 illustrates an example matrix multiplication command according to an embodiment. In this example, a command instructs a matrix multiplication unit to multiply a matrix operand A comprising R 2D arrays 410a-c having dimension [P, K, R] with operand B comprising R 2D arrays 411a-c of dimension [K, Q, R], and conditionally add the result of the multiplication with matrix operand C 412 of dimension [P, Q]. The output 413 is an array of dimension [P, Q], where K, P, Q, and R are integers. An example structure of the command may contain the following logical fields:

```
struct TtuDescType2 {
  int P_dim;
  int K_dim;
  int Q_dim;
  int R_dim;
  int part_P_dim;
  int part_Q_dim;
  int A_base_addr_bytes;
  int A_R_dim_stride;
  int A_P_dim_stride;
  int A_K_dim_stride;
  int A_part_P_dim_stride;
  int B_base_addr_bytes;
  int B_R_dim_stride;
  int B_K_dim_stride;
  int B_Q_dim_stride;
  int B_part_Q_dim_stride;
  int C_base_addr_bytes;
  int C_P_dim_stride;
  int C_Q_dim_stride;
  int C_part_P_dim_stride;
  int C_part_Q_dim_stride;
  int out_base_addr_bytes;
  int out_P_dim_stride;
  int out_Q_dim_stride;
  int out_part_P_dim_stride;
  int out_part_Q_dim_stride;
  int out_rmem_P_dim_size;
  int out_rmem_Q_dim_size;
  int sem_out_ready_valid;
  int sem_out_ready_val;
  int sem_out_ready_id;
  int sem_out_valid_valid;
  int sem_out_valid_val;
  int sem_out_valid_id;
};
```

Table 3 contains example descriptions for the fields above.

TABLE 3

| Field Name | Description | | |
|---|---|---|---|
| P_dim | Dimensions of the operands. | | |
| K_dim | | | |
| Q_dim | | | |
| R_dim | | | |
| part_P_dim | Output sub-partition dimension on which to synchronize with the | | |
| part_Q_dim | semaphores. | | |
| A_base_addr_bytes | Starting address in off-chip memory for operand_A, operand_B, | | |
| B_base_addr_bytes | operand_C, and output. In units of bytes. | | |
| C_base_addr_bytes | | | |
| out_base_addr_bytes | | | |
| A_R_dim_stride | Address increment for each dimension for each operand. | | |
| A_P_dim_stride | | | |
| A_K_dim_stride | | | |
| B_R_dim_stride | | | |
| B_K_dim_stride | | | |
| B_Q_dim_stride | | | |
| C_P_dim_stride | | | |
| C_Q_dim_stride | | | |
| out_P_dim_stride | | | |
| out_Q_dim_stride | | | |
| sem_out_ready_valid | Semaphores to wait and signal on for each output sub-tile. A matrix | | |
| sem_out_ready_val | multiplication unit may: | | |
| sem_out_ready_id | | • | Perform a wait on sem_out_hbm_rdy and/or sem_out_rmem_rdy |
| sem_out_valid_valid | | • | Produce a sub-partition output of dimension out_tile_P_dim by |
| sem_out_valid_val | | | out_tile_Q_dim |
| sem_out_valid_id | | • | Perform a signal on sem_out_hbm_valid or sem_out_rmem_valid |

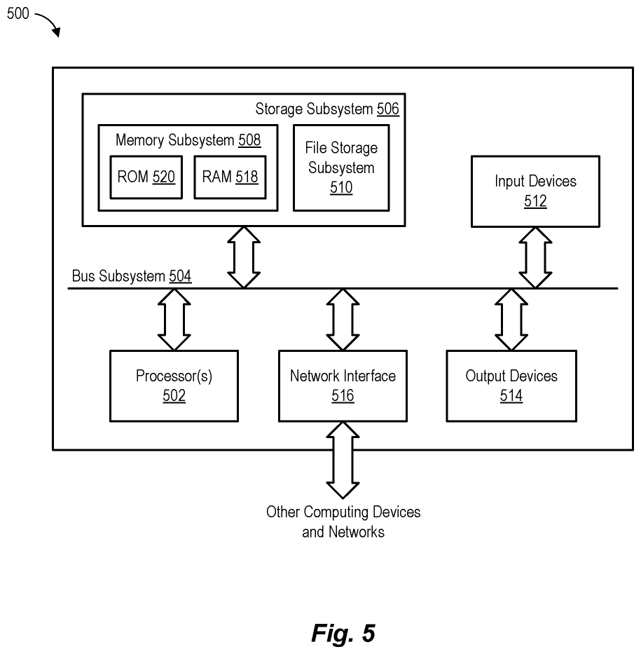

FIG. 5 depicts a simplified block diagram of an example system 500, which can be used to implement the techniques described in the foregoing disclosure. In some embodiments, system 500 may be used to implement system 100. As shown in FIG. 5, system 500 includes one or more processors 502 that communicate with a number of devices via one or more bus subsystems 504. These devices may include a storage subsystem 506 (e.g., comprising a memory subsystem 508 and a file storage subsystem 510) and a network interface subsystem 516. Some systems may further include user interface input devices 512 and/or user interface output devices 514.

Processors 502 may be optimized for machine learning as described herein. Processors 502 may comprise subsystems for carrying out neural network operations and executing commands to control the processing of multi-dimensional data, for example. Processors 502 may comprise various subsystems, such as vector processors, matrix multiplication units, control state machines, and one or more on-chip memories for storing input and output data, for example. In some embodiments, processors 502 are an array of processors coupled together over multiple busses for example for processing machine learning data in parallel, for example.

Bus subsystem 504 can provide a mechanism for letting the various components and subsystems of system 500 communicate with each other as intended. Although bus subsystem 504 is shown schematically as a single bus, alternative embodiments of the bus subsystem can utilize multiple busses.

Network interface subsystem 516 can serve as an interface for communicating data between system 500 and other computer systems or networks. Embodiments of network interface subsystem 516 can include, e.g., Ethernet, a Wi-Fi and/or cellular adapter, a modem (telephone, satellite, cable, etc.), and/or the like.

Storage subsystem 506 includes a memory subsystem 508 and a file/disk storage subsystem 510. Subsystems 508 and 510 as well as other memories described herein are examples of non-transitory computer-readable storage media that can store executable program code and/or data that provide the functionality of embodiments of the present disclosure.

Memory subsystem 508 comprise one or more memories including a main random access memory (RAM) 518 for storage of instructions and data during program execution and a read-only memory (ROM) 520 in which fixed instructions are stored. File storage subsystem 510 can provide persistent (e.g., non-volatile) storage for program and data files, and can include a magnetic or solid-state hard disk drive, an optical drive along with associated removable media (e.g., CD-ROM, DVD, Blu-Ray, etc.), a removable flash memory-based drive or card, and/or other types of storage media known in the art.

It should be appreciated that system 500 is illustrative and many other configurations having more or fewer components than system 500 are possible.

### FURTHER EXAMPLES

Each of the following non-limiting features in the following examples may stand on its own or may be combined in various permutations or combinations with one or more of the other features in the examples below.

In various embodiments, the present disclosure may be implemented as a system (e.g., an electronic computation system), method (e.g., carried out on one or more systems), or a non-transitory computer-readable medium (CRM) storing a program executable by one or more processors, the program comprising sets of instructions for performing certain processes described above or hereinafter.

For example, in some embodiments the present disclosure includes a system, method, or CRM for machine learning comprising: one or more processors; and a non-transitory computer-readable medium storing a program executable by the one or more processors, the program comprising sets of instructions for: receiving, by a processor, a plurality of commands to perform machine learning operations on multi-dimensional data, the commands comprising data structures, the data structures comprising: a plurality of fields describing a plurality of dimensions of the multi-dimensional data; and a plurality of fields describing synchronization of a particular command process with one or more other processes at a plurality of occurrences of partial completion of the particular command process; and executing, by the processor, the commands to perform the machine learning operations on the multi-dimensional data.

In one embodiment, the multi-dimensional data comprises tensors, and wherein the commands perform a function on one or more complete tensors without the execution of other commands.

In one embodiment, the command performs a data movement or matrix multiplication operation.

In one embodiment, the commands describe operations on the multi-dimensional data.

In one embodiment, the commands repeat a plurality of same operations on the multi-dimensional data.

In one embodiment, at least one command addresses first multi-dimensional data that does not fit in on-chip memory of the at least one processor.

In one embodiment, at least a portion of the first multi-dimensional data operated on during execution of the at least one command is stored in main memory.

In one embodiment, the machine learning operations are neural network operations.

In one embodiment, the multi-dimensional data comprises multi-dimensional matrices of data, and wherein the commands encode the dimensions of the multi-dimensional matrices of data.

In one embodiment, the commands specify a plurality of dimension sizes for a plurality of dimensions of one or more matrices.

In one embodiment, the commands comprise a base address for at least one multi-dimensional matrix of data.

In one embodiment, the commands comprise a size of each dimension for at least one multi-dimensional matrix of data.

In one embodiment, the commands comprise a stride size for at least one multi-dimensional matrix of data.

In one embodiment, the commands comprise a data type for at least one multi-dimensional matrix of data.

In one embodiment, the commands comprise a base address, a size of each dimension, a stride size, and a data type for at least one multi-dimensional matrix of data.

In one embodiment, the commands encode synchronization points, and wherein a plurality of commands synchronize on a partially processed multi-dimensional data set at the synchronization points.

In one embodiment, a dependent command synchronizes a partially processed multi-dimensional data set in main memory being operated on by another command.

In one embodiment, at least one command executes a wait on the occurrence of a predefined event specified in the at least one command.

In one embodiment, at least one command performs a data transaction on the occurrence of a predefined event specified in the at least one command.

In one embodiment, at least one command generates a signal on the occurrence of a predefined event specified in the at least one command.

The above description illustrates various embodiments along with examples of how aspects of some embodiments may be implemented. The above examples and embodiments should not be deemed to be the only embodiments, and are presented to illustrate the flexibility and advantages of some embodiments as defined by the following claims. Based on the above disclosure and the following claims, other arrangements, embodiments, implementations and equivalents may be employed without departing from the scope hereof as defined by the claims.

What is claimed is:

1. A system for machine learning comprising:
one or more processors; and
a non-transitory computer-readable medium storing a program executable by the one or more processors, the program comprising sets of instructions for:
receiving, by a processor, a plurality of commands to perform machine learning operations on multi-dimensional data, the commands comprising data structures, the data structures comprising:
a plurality of fields describing a plurality of dimensions of the multi-dimensional data; and
a plurality of fields describing synchronization of a particular command process with one or more other processes at a plurality of occurrences of partial completion of the particular command process; and
executing, by the processor, the commands to perform the machine learning operations on the multi-dimensional data.

2. The system of claim 1, wherein the multi-dimensional data comprises tensors, and wherein the commands perform a function on one or more complete tensors without the execution of other commands.

3. The system of claim 1, wherein the command performs a data movement or matrix multiplication operation.

4. The system of claim 1, wherein the commands describe operations on the multi-dimensional data.

5. The system of claim 1, wherein the commands repeat a plurality of same operations on the multi-dimensional data.

6. The system of claim 1, wherein at least one command addresses first multi-dimensional data that does not fit in on-chip memory of the at least one processor.

7. The system of claim 6, wherein at least a portion of the first multi-dimensional data operated on during execution of the at least one command is stored in main memory.

8. The system of claim 1, wherein the machine learning operations are neural network operations.

9. The system of claim 1, wherein the multi-dimensional data comprises multi-dimensional matrices of data, and wherein the commands encode the dimensions of the multi-dimensional matrices of data.

10. The system of claim 9, wherein the commands specify a plurality of dimension sizes for a plurality of dimensions of one or more matrices.

11. The system of claim 9, wherein the commands comprise a base address for at least one multi-dimensional matrix of data.

12. The system of claim 9, wherein the commands comprise a size of each dimension for at least one multi-dimensional matrix of data.

13. The system of claim 9, wherein the commands comprise a stride size for at least one multi-dimensional matrix of data.

14. The system of claim 9, wherein the commands comprise a data type for at least one multi-dimensional matrix of data.

15. The system of claim 9, wherein the commands comprise a base address, a size of each dimension, a stride size, and a data type for at least one multi-dimensional matrix of data.

16. The system of claim 1, wherein the commands encode synchronization points, and wherein a plurality of commands synchronize on a partially processed multi-dimensional data set at the synchronization points.

17. The system of claim 16, wherein a dependent command synchronizes a partially processed multi-dimensional data set in main memory being operated on by another command.

18. The system of claim 17, wherein at least one command executes a wait, executes a data transaction, or generates a signal on the occurrence of a predefined event specified in the at least one command.

19. A method of processing multi-dimensional machine learning data comprising:
receiving, by a processor, a plurality of commands to perform machine learning operations on multi-dimensional data, the commands comprising data structures, the data structures comprising:
a plurality of fields describing a plurality of dimensions of the multi-dimensional data; and
a plurality of fields describing synchronization of a particular command process with one or more other processes at a plurality of occurrences of partial completion of the particular command process; and
executing, by the processor, the commands to perform the machine learning operations on the multi-dimensional data.

20. A non-transitory computer-readable medium storing a program executable by one or more processors, the program comprising sets of instructions for:
receiving, by a processor, a plurality of commands to perform machine learning operations on multi-dimensional data, the commands comprising data structures, the data structures comprising:
a plurality of fields describing a plurality of dimensions of the multi-dimensional data; and
a plurality of fields describing synchronization of a particular command process with one or more other processes at a plurality of occurrences of partial completion of the particular command process; and
executing, by the processor, the commands to perform the machine learning operations on the multi-dimensional data.
